(19) United States
(12) Patent Application Publication
(10) Pub. No.: US 2006/0130112 A1
(43) Pub. Date: Jun. 15, 2006

(54) Streaming or real-time data television programming

(76) Inventors: Patrick Stewart, Dublin (IE); Niall Deegan, Dublin (IE); Fergus McCarthy, Dublin (IE); Lawrence Fee, Dublin (IE)

Correspondence Address: JACOBSON HOLMAN PLLC, 400 SEVENTH STREET N.W., SUITE 600, WASHINGTON, DC, 20004, US

(21) Appl. No.: 10/517,826

(22) PCT Filed: Jun. 14, 2002
(86) PCT No.: PCT/IE02/00080

§ 371 Date: Jan. 9, 2006

(51) Int. Cl. H04N 7/173; H04N 7/16; H04N 5/38

(52) U.S. Cl. 725/115; 348/723; 725/114; 725/144; 725/145; 725/117; 725/147; 725/109; 725/110

(57) ABSTRACT

The invention provides a method and system of broadcasting television quality programmes in real time. A dedicated uncontended connection line between a production process centre (PPC) (2) and a remote service computer provider (3) provides quality programming to be broadcast from the PPC (2) to a number of remote client devices (4) via the remote service provider computer (3).

### INTRODUCTION

This invention relates to a method of broadcasting television-quality programming in real time to a client device in a system comprising a production process centre (PPC), a remote service provider computer and a plurality of remote client devices each of which is connected to the remote service provider computer by way of an uncontended broadband communication channel, the production server computer transmitting a television-quality programme to the remote client device via the remote service provider computer.

Nowadays, more people are beginning to have access to and use broadband communication technology and IP based technology. Broadband communication technology, or broadband as it is more commonly referred to, is now widely used in the mobile telecommunications industry as well as the internet connection industry. Using broadband communication technology, individuals can access and download information using suitable client devices such as a PC or mobile telephone, faster than was previously possible with narrow band communication technology. The ability of the user to access and download information quicker than before has led to significant changes in the content of the material that is accessible by the users. A richer more detailed content can now be offered to the broadband user. Service providers such as Internet Service Providers (ISPs) in the internet connection industry and Mobile Communication Network Service Providers in the mobile telecommunications industry are constantly looking to new ways of providing richer content to the broadband users while simultaneously broadband users are demanding richer content from the service providers. One such type of rich content being demanded by the users is television-quality programming.

By television-quality programmes, what is meant is programmes that may be viewed on a client device with no appreciable difference in quality to the pictures noticeable by the client device user, than the quality of pictures received by a television set receiving programmes from a normal satellite or terrestrial television broadcaster. Television-quality programming is television quality programmes being broadcast ‘Live’, in other words, being broadcast twenty four hours a day, seven days a week. Television quality programming may include a plurality of separate channels each having their own television quality programmes broadcast thereon.

Many parties in the internet connection and mobile telecommunications industries have tried to have television-quality programmes, but in reality the majority consist of a series of “stills” photographs of a scene taken a short time period apart and then played in sequence or delivered by regular streaming across the public internet to a client device. This leads to an unsatisfactory audio visual experience with a stuttering picture that is not television quality programming. Additionally, these have been one-off broadcasts and not television-quality programming broadcasting television quality programmes around the clock.

There are, however, several problems associated with delivering television-quality programming to a client device. In the case of the Internet Service Provider (ISP), the ISP receives a request from the client device to access a television programme that is being webcast in real time. The ISP must then route a data communication link to the web-page of the organisation making the webcast through the public internet and deliver that programme in real time to the client device. The problem with routing the web-cast through the internet is that the route established between the desired web page and the client device may be a rather congested and circuitous route. This will cause the transfer of information between the web page and the client device to be quite slow and the rate of data transfer from the web page to the client device will be quite low, well below the rate required for television quality programmes. If the data is transferred at a lower rate the television programme will play for a short period of time before stopping to buffer enough data before it may continue playing. This results in a stop-start broadcast, which is not a television-quality programme broadcast and is unacceptable to the user.

Another problem associated with broadcasting television-quality programmes in real time is that the connection line intermediate the ISP and the production server over the internet is not a steady constant bandwidth connection and its bandwidth may vary over time. This is unacceptable as a loss in bandwidth results in a reduced quality of transmission and ultimately one or more channels being broadcast with the webcast from the web page may be lost altogether. This also is quite unacceptable as transmission may be terminated mid-programme. The programme broadcaster has heretofore been unable to provide the so-called “Quality of Service” or in other words television quality programming due to the fluctuations in available bandwidth and uncertainty in connection over the network.

Similar problems are experienced by client devices attempting to access broadcasts over a mobile telecommunications network. Up until now, the quality of content accessible was of a relatively low standard, mobile client devices have, in general, small memory capacity and buffering of programme data takes up a large quantity of available memory. Furthermore, the users of client devices often find that the programme being broadcast is encoded in a format that is not stored on their machine. In order for the users to view the broadcast they would first have to download the required software, which was also time consuming and expensive to do. There are problems associated with processing and memory power of the client device type and screen type. Some mobile network operators are offering still imaging or basic animation with a mixture of audio and text. They do not however offer television quality programming.

Heretofore, others have claimed to have developed methods of broadcasting television-quality programmes in real time but by and large these have comprised webcasts in which the client has to download a large portion of the television programme in advance, thereby not resulting in the broadcasting of television-quality programmes in real-time. Other solutions have resulted in poor quality pictures with stop start broadcasts and packet loss at low bit rates that do not give the television quality programming experience. Therefore, it is an object of the present invention to overcome at least some of these difficulties and to provide a method of broadcasting television-quality programmes in a simple and efficient manner.

### STATEMENTS OF INVENTION

According to the invention there is provided a method of broadcasting television-quality programmes in real time to a client device in a system comprising a Production Process Centre (PPC), a remote service provider computer and a plurality of remote client devices each of which is connected to the service provider computer by way of an uncontended broadband communication channel, the method comprising the production process centre transmitting a television quality programme to the remote client device via the remote service provider computer, the method further comprises the step of:
(a) the production process centre receiving television programme data from a remote television programme source;
(b) the production process centre processing the received television programme data and converting the television programme data into a plurality of digital television programme viewing formats;
(c) transmitting at least one of the television programme viewing formats to the remote service provider computer along a dedicated uncontended connection line interconnecting the production process centre and the remote service provider computer; and

The advantage of having this method of broadcasting television-quality programmes in real time is that quality of service is guaranteed to the client device. In this way, by having a dedicated uncontended connection line between the production process centre and the service provider computer, the quality of the programming being broadcast by the production process centre will not be degraded. By using this method several different types of client devices are serviced by the one production process centre as a number of digital television programme viewing formats are provided by the production process centre. Each client device can select the format suitable for viewing on that device.

In one embodiment of the invention there is provided a method in which the remote service provider computer comprises an Internet Service Provider (ISP) computer and the step of transmitting at least one of the television programme viewing formats to the service provider computer comprises transmitting at least one of the television program viewing formats to the ISP computer. In this way, the television quality programming may be viewed on a PC or other similar device such as a set top device. By routing the programs through the ISP the client device may be billed by the ISP for both internet connection services and television broadcasting services.

In another embodiment of the invention there is provided a method in which the remote service provider computer comprises a mobile communications network service provider computer, and the step of transmitting at least one of the television programme viewing formats to the service provider computer comprises transmitting at least one television programme viewing format to the mobile communications network service provider computer. In this way television quality programs may be broadcast to a client device that is a mobile telephone or other such similar device. This will allow television quality programming always on television to be viewed on a mobile telephone. Alternatively, the remote service provider computer could comprise a cable network service provider computer, which will allow the cable network service provider to bill the cable user for this television viewing service as well as the other services provided by the cable network provider.

In another embodiment of the invention there is provided a method in which the step of transmitting at least one television programme viewing format to the service provider computer over a dedicated uncontended connection line further comprises transmitting at least one television programme viewing format to the service provider computer over a dedicated uncontended dual connection link. By having a dual connection link redundancy is introduced into the method and the method further insures that a signal is always delivered to the service provider computer from the production process centre. This is necessary to provide the quality of service required for television. Should one part of the dedicated uncontended connection link fail the other part of the link will see to it that the television quality programming is still delivered to the service provider computers.

In a further embodiment of the invention there is provided a method in which the step of transmitting at least one television programme viewing format to the service provider computer over a dedicated uncontended connection line further comprises transmitting at least one television programme viewing format to the service provider computer over a dedicated uncontended satellite link. By transmitting at least one television programme viewing format to the service provider computer over a dedicated uncontended satellite link further redundancy is introduced into the system, which will help insure the necessary quality of service is delivered to the service provider computer.

In another embodiment of the invention there is provided a method in which the step of processing the received television programme data further comprises decoding the received television programme data into standard Serial Digital Interface (SDI) format. By having the television programme data in a single serial digital interface format the data will be more easily manipulated and significant savings can be made in programming of the converters.

In another embodiment of the invention there is provided a method in which the step of processing the received television programme data further comprises decoding the received television programme data into standard multi format. It is envisaged that it may be preferable to have standard multi format as various types of incoming television programme data may not lend themselves to a uniform single format and a quicker conversion can be achieved by having the data in multi format.

In another embodiment of the invention there is provided a method in which the received programme data is passed through a multiple signal decoder to decode the received television programme data into standard format. A multiple signal decoder will receive data in any one of a number of different formats and decode it into a standard format so that the data may be manipulated in the desired manner. By having all the data going to a multiple signal decoder expensive routings need not have to be carried out.

In one embodiment of the invention there is provided a method in which the step of processing the received television programme data further comprises editing the received television programme data. By editing the received television programme data subtitles as well as dubbing may be carried out on the television programme data. Furthermore, advertisement commercials may be inserted into the received television programme data. These advertising commercials may be targeted to a specific audience for the programme and lend greater flexibility to sponsorship of programmes.

In another embodiment of the invention there is provided a method in which the step of converting the television programme data into a plurality of digital television viewing formats comprises passing the television programme data through a multiple encoding station. By passing the television programme data through a multiple encoding station, the data is prepared into a number of different formats that may be received by the various client devices. It is envisaged that the client devices themselves may have different viewing software packages installed thereon, therefore as all the machines will not necessary have the same up to date viewer it is necessary to provide the data in a number of different formats. By passing the television programme data through a multiple encoding station the multiple formats will be generated automatically.

In another embodiment of the invention there is provided a method in which there is provided the intermediate step of logging the received television programme data in production server computer memory for future use. By logging the received television programme data in production server memory the data may be archived and used again for highlight, re-selling or compilation programmes at a later date.

In another embodiment of the invention there is provided a method in which the method further comprises the intermediate step of storing metadata relating to each piece of received television programme data in production server computer memory. By storing the metadata relating to each piece of data stored in production server memory, the data may be retrieved in a quick and efficient manner without undue delay.

In a further embodiment of the invention there is provided a method in which the method further comprises the intermediate step of pre-encoding the television programme data before converting the television programme data into a plurality of digital television viewing formats. By pre-encoding television programme data the television programme data will be stripped of any unnecessary material so that the bare minimum of the data that must be sent to the client device in order to provide a television quality programme is sent to the client device. This further helps to reduce the amount of bandwidth that will be necessary to transmit the television quality programme data to the client devices.

In another embodiment of the invention there is provided a method in which there is provided a data centre computer having data centre memory intermediate the production process centre and the service provider computer and connected to the production process centre and the service provider computer by way of the dedicated uncontended connection line, and the television programme viewing format transmitted to the remote service provider computer from the production process centre is stored in the data centre memory, the datacentre computer transmitting the television programme viewing format onwards to the remote service provider computer. By having a data centre computer greater security to the production process centre will be provided as direct connections between the production process centre and the service provider computers will not have to be provided. The data centre can act as an intermediary between the production process centre and the service provider computer. This enhances the security and the integrity of the method.

In another embodiment of the invention there is provided a method in which there are a plurality of data centre computers, each data centre computer being connected to at least one other data centre computer by way of a back channel multiple cross connect uncontended connection line, the method including the step of each data centre sharing a television programme viewing format with the data centre computer connected thereto over the back channel multiple cross connect uncontended connection line. By transferring television programme viewing format between two data centres over a back channel multiple cross connect uncontended connection line, the data centres are carrier neutral and therefore a number of different routes will be open to the data centre computer when it has to send data to another data centre. This again helps to maintain a level of quality of service sufficient for television quality programmes.

In one embodiment of the invention there is provided a method in which the data centre computer is provided with means to edit the television programme viewing format and the method further comprises the step of the data centre computer editing the television programme viewing format received from the production server computer. By allowing the data centre computer to edit the television programme viewing format advertising commercials as well as editing, dubbing and subtitling that are relevant to the location of the data centre computer may be carried out. This would be particularly relevant if when the production process centre is in an English speaking county and is broadcasting to a client device, which is in another country having a different language. Dubbing in the language of the receiving country may be inserted at the data centre computer in that locality. The data centre computer may insert location specific advertisement commercials into the television programme viewing format.

In another embodiment of the invention there is provided a method in which the method further comprises the initial step of the remote client device selecting a television programme viewing format for reception from the remote service provider computer. By using this method, the client device will be able to chose a viewing format that corresponds to a suitable viewer installed on the client device.

In one embodiment of the invention there is provided a method of controlling the transmission of television quality programmes to a remote client device by a service provider computer, in a system comprising a plurality of remote client devices each connected to the service provider computer by way of an uncontended broadband connection (5), and a remote production process centre connected to the service provider computer, the service provider computer receiving a television quality programme from the remote production process centre and the service provider computer transmitting the television quality programme to the remote client device, the method further comprises the steps of:
(a) the service provider computer receiving television-quality programmes from the remote production process centre over a dedicated uncontended connection line inter-connecting the remote production process centre and the service provider computer in a plurality of television-quality programme viewing formats; and
(b) on request from one of the remote client devices, transmitting one of the television-quality programme viewing formats received from the remote production process centre to the remote client device over the uncontended broadband connection line.

By using this method the service provider computer can provide a guaranteed quality of service to the client device as it will be guaranteed to receive the relevant television quality programme data from the production process centre over the uncontended dedicated connection line. It will be able to provide a number of different television viewing formats to the client device on request. This is particular useful and will enable the service provider computer to provide additional services to the client devices that subscribe thereto.

In another embodiment of the invention there is provided a method in which the initial step of the remote client device selecting a television-quality programme viewing format is performed. In this way, the remote client device will be able to select a suitable viewing format that will be able to be viewed on that client device. The client device will not have to undergo a lengthy download of software to install a suitable viewer as it will be able to chose a suitable format that it already has the viewer installed on the client device.

In another embodiment of the invention there is provided a method in which the service provider computer comprises an Internet service provider (ISP) computer and the ISP computer performs the steps of receiving the television-quality programmes and transmitting one of the television-quality programme viewing formats to the remote client device. By using this method the service provider will be allowed provide greater functionality in services to their clients as well as being able to generate additional revenue for providing not only internet access but also television broadcasting.

In another embodiment of the invention there is provided a method in which the service provider computer comprises a mobile communications network service provider computer and the steps of receiving the television-quality programmes and transmitting one of the television-quality programme viewing formats to the remote client device are performed by the mobile communication network service provider computer. In this way mobile communication network service providers will be able to generate income from providing television quality programming to a mobile communication device. The client device user will be able to view television quality programmes on their mobile client devices, which was heretofore not possible. Another advantage to the mobile communication network service provider is that they are providing an additional service that is heretofore unknown. By broadcasting always on live television the mobile user may access programs or such items of interest on their mobile phone.

It will be appreciated that in this specification a mobile communications network service provider can incorporate not along standard mobile communications and telephony but includes satellite service distributors to provide service to virtually anywhere either on land, at sea or in the air.

In another embodiment of the invention there is provided a method in which the service provider computer comprises a cable network service provider computer and the cable network service provider computer performs the steps of receiving the television quality programmes and transmitting one of the television quality programme viewing formats to the remote client device.

In one embodiment of the invention there is provided a method in which the method further comprises the step of inserting advertisement commercials into the television-quality programmes by the service provider computer before onward transmission to the remote client device. In this way the service provider computer can generate revenue by inserting advertisement material into the television quality programmes as well as controlling the content of the television quality programmes. Furthermore, the service provider computer may ensure the type of advertising material that is being inserted into television quality programmes, which may be location specific.

In a further embodiment of the invention there is provided a method further comprising the step of the service provider computer monitoring television-quality programmes sent to a remote client device. By monitoring the television-quality programmes the service provider may ascertain the usage of the system and may generate billing information or any such type of report that may be necessary from time to time.

In another embodiment of the invention there is provided a method in which there is further provided a remote data centre computer connected to the dedicated uncontended connection line intermediate the service provider computer and the remote production process centre and television-quality programmes are passed through the data centre computer via a secure cross connect en route to the service provider computer. By having a data centre computer greater security may be introduced into the system in that no direct connection between the service provider and the production process centre need be provided.

In another embodiment of the invention there is provided a method in which the method comprises the step of inserting advertisement material into the television quality programmes by the remote data centre computer before onward transmission to the service provider computer. This is seen as particularly useful as the data centre computer may be in a location that the predominant language is different to that of the production process centre. In this way advertisement commercials relevant to the locality as well as subtitling and dubbing in the language of the locality may be provided at the data centre.

In a further embodiment of the invention there is provided a method of receiving real time television-quality programmes in a client device, the client device being part of a system comprising a plurality of client devices each connected to a remote service provider computer by way of an uncontended broadband communication link, and a remote production process centre connected to the remote service provider computer by a dedicated uncontended connection line therebetween, the method comprising the steps of:
(a) the client device making a television-quality programme viewing request to the remote production process centre via the remote service provider; and
(b) receiving the television-quality programme associated with the television quality programme viewing request in a suitable television quality programme viewing format.

This is seen as a particularly useful method of receiving real time television quality programmes in a client device. The client device is guaranteed quality of service from the production process centre and can therefore receive a program in uninterrupted fashion.

In another embodiment of the invention there is provided a method in which the method includes the initial step of the client device selecting a suitable television quality programme viewing format from a plurality of available television quality programme viewing formats. In this way the client device can select a suitable television programme viewing format that the client device has the software to view already installed on the client device.

In another embodiment of the invention there is provided a method in which the service provider computer is an Internet Service Provider (ISP) computer and the step of making a television quality program viewing request to the remote production process centre is made via the ISP computer.

In one embodiment of the invention there is provided a method in which the service provider computer is a mobile communications network service provider computer and the step of making a television-quality program viewing request to the remote production process centre is made via the mobile communications network service provider computer.

In a further embodiment of the invention there is provided a method in which the service provider computer is a cable network service provider computer and the step of making a television quality program viewing request to the remote production process centre is made via the cable network service provider computer.

In another embodiment of the invention there is provided a method in which the method further comprises the initial steps of the client device registering with the remote service provider computer as a system user. In this way, the service provider can restrict users of the system to those who are registered. Therefore, monthly subscriptions may be collected as well as the service provider having a definite amount of bandwidth that it must supply to ensure coverage to all subscribers.

In another embodiment of the invention there is provided a system for broadcasting television-quality programmes to a client device comprising a production process centre, a remote service provider computer and a plurality of remote client devices each connected to the remote service provider computer by way of an uncontended broadband communication link, the production process centre transmitting a television-quality programme to the remote client device via the remote service provider computer, the system further comprising:
(a) a dedicated uncontended connection line inter-connecting the production process centre and the service provider computer, the production process centre sending the television-quality programme to the service provider computer along the dedicated uncontended connection line;
and the production process centre comprising:
(b) a receiver for receiving television programme data from remote television programme source;
(c) a processor for processing the received programme data and means to convert the television programme data into a plurality of television viewing formats;
(d) a transmitter for transmitting the television quality programme in at least one of the television viewing formats to the service provider computer along the dedicated uncontended connection line.

This system is seen as particularly useful, as it will allow television quality programmes to be broadcast to a client device in an uninterrupted fashion without requiring the client device to download large sections of data in advance of viewing the television programme data. The client device will have a choice of a number of different formats in which to view the television data and therefore lengthy downloads of software before viewing may commence and can be obviated.

In one embodiment of the invention there is provided a system in which the remote service provider computer comprises an Internet Service Provider (ISP) computer. Alternatively, the remote service provider could be a mobile communications network service provider computer or a cable network service provider computer. This will allow internet users, mobile telephone users and cable provider users respectively to view television quality programmes on their individual client devices in a way that was not previously possible.

In a further embodiment of the invention there is provided a system in which the production process centre's processor further comprises means to decode a plurality of incoming data formats into a single standard format. By decoding the plurality of incoming data formats into a single standard format it will be far easier to edit the data such as inserting advertising material, subtitles and the like.

In another embodiment of the invention there is provided a system in which the production process centre comprises a pre-encoder to pre-encode the television programme data. By pre-encoding the television programme data the minimum amount of data that must be sent to the client device to provide a clear television quality experience to the user will be achieved.

In one embodiment of the invention there is provided a system as claimed in which the production process centre's means to convert the television programme data into a plurality of digital television viewing formats comprises a multiple encoding station. By having a multiple encoding station a plurality of different formats may be provided for each of the client devices. It is envisaged that various different types of devices may have different viewing software stored thereon. In this way, the client device may select the television data in a format that is suitable for that device.

In a further embodiment of the invention there is provided a system in which the production process centre has production process centre memory and means to log television programme data in production process centre memory. This will allow future access and control of the television programme data so compilation programmes and the like may be created in the future.

In one embodiment of the invention there is provided a system in which the production process centre has means to store metadata relating to television programme data in production process centre memory. In this way data that is stored in the production process centre may be retrieved in a simple, quick and efficient manner.

In a further embodiment there is provided a system in which the dedicated uncontended connection line is a dual-connectivity dedicated uncontended connection line. This is seen as particularly useful as if one section of the dual-connectivity dedicated uncontended connection line should fail, the other section will transfer the television quality programme viewing format to the end user without any interruption in the programmes viewing. This ensures the level of quality of service necessary for television programming.

In another embodiment of the invention there is provided a system in which there is additionally provided a satellite link connecting the production process centre and the remote service provider computer. This will provide further redundancy and back-up to the dual-connectivity dedicated uncontended connection line or other uncontended dedicated connection line.

In one embodiment of the invention there is provided a system in which there is provided a remote data centre computer connected to the dedicated uncontended connection line intermediate the production process centre and the remote service provider computer acting as an interface between the production process centre and the remote service provider computer, all data traffic between the production process centre and the service provider computer passing through the remote data centre. By having a data centre computer greater security and integrity to the production process centre is provided as it no longer has to have direct connections to the service provider computer. This is seen as preferred for security reasons. By having a data centre intermediate the production process centre and the service provider computer location specific advertising material may be inserted into the television quality programming at the data centre.

In another embodiment of the invention there is provided a system in which the remote data centre computer further comprises a media server computer having means to receive and transmit television quality programming data. The media server will allow for programme data to be taken in at the data centre and processed at the data centre. The media server will control the operation of the data centre computer and the transfer of data to and from service provider computers as well as logging data sent to them.

In one embodiment of the invention there is provided a system in which there are a plurality of data centres, each datacentre being connected to at least one other datacentre by way of a multiple back channel cross connect uncontended connection line. This is seen as a particularly efficient way of connecting the data centres as the connection is carrier neutral. By having a number of different carriers, should one have difficulty in transmitting the signal then another carrier may be selected within a very short period of time and continuity is maintained.

In a further embodiment of the invention there is provided a system in which there are a plurality of service provider computers located adjacent each data centre computer and the data centre computer controls the flow of television-quality programme data to each of the service provider computers. By having a number of service provider computers located adjacent a data centre a more economic efficient connection from the production process centre to the service provider via a data centre may be achieved. In this way, the minimum amount of cable must be used to connect the maximum number of service providers.

In a further embodiment of the invention there is provided a system in which the data centre computer comprises means to edit television programme data received from the production process centre. By having means to edit the television programme data at the data centres, advertising material, dubbing and editing relevant to the locality may be carried out at the data centre rather than at the production process centre, which may be in another country with a different national language.

In a further embodiment of the invention there is provided a system for broadcasting television-quality programmes to a remote client device comprising a remote production process centre, a service provider computer and a plurality of remote client devices each connected to the service provider computer by way of an uncontended broadband communication channel, the service provider computer receiving a television-quality programme from the remote production process centre and transmitting the television-quality programme onwards to a remote client device, the system further comprising:
(a) a dedicated uncontended connection line interconnecting the remote production process centre and the service provider computer, the service provider computer receiving the television-quality programme from the remote production process centre over the dedicated uncontended connection line in a plurality of television-quality programme viewing formats; and
(b) the service provider computer having a receiver for receiving a television viewing request from a remote client device and a transmitter for transmitting one of the television-quality programme viewing formats over the uncontended broadband connection line to the remote client device.

This system is seen as particularly useful as the service provider computers now have the system for delivering television quality programmes with the necessary quality of service to client devices that was previously impossible. This is a simple and cost efficient system that may be implemented with the minimum of difficulty.

In another embodiment of the invention there is provided a system in which there is provided a remote data centre computer connected to the dedicated uncontended connection line intermediate the service provider computer and the remote production process centre and television-quality programmes are passed through the data centre computer en route to the service provider computer. This remote data centre computer will enable greater security of the production process centre to external attack. Furthermore additional buffering may be carried out at the data centre computer.

In another embodiment of the invention there is provided a system in which the service provider computer is an Internet Service Provider (ISP) computer. Alternatively the service provider computer could be a mobile communications network provider computer or a cable network service provider computer.

In a further embodiment of the invention there is provided a system in which the service provider computer has means to monitor the television viewing requests of each of the remote client devices. This will allow the service provider computer to calculate the amount of television viewing requests made by each of the remote client devices and generate revenue therefrom.

In one embodiment of the invention there is provided a system in which the service provider computer has means to edit the television quality programmes. This will allow advertising material pertinent to the locality of the client devices to be inserted at the service provider rather than at the production process centre.

In one embodiment of the invention there is provided a computer program comprising program instructions for causing a computer to carry out the method steps performed by the production process centre in any of claims 1 to 20.

In another embodiment of the invention there is provided a computer program comprising program instructions for causing a computer to carry out the method steps performed by the service provider computer in any of claims 21 to 30. These computer programmes can be stored on computer readable mediums such as a Floppy Disc, DVD, CD Rom, or other such computer readable mediums or alternatively the program could be stored on a carrier signal, such as an optical signal, electrical signal, radio signal or other such type of carrier signal.

### DETAILED DESCRIPTION OF THE INVENTION

The invention will now be more clearly understood from the following description of some embodiments thereof given by way of example only with reference to the accompanying drawings in which:

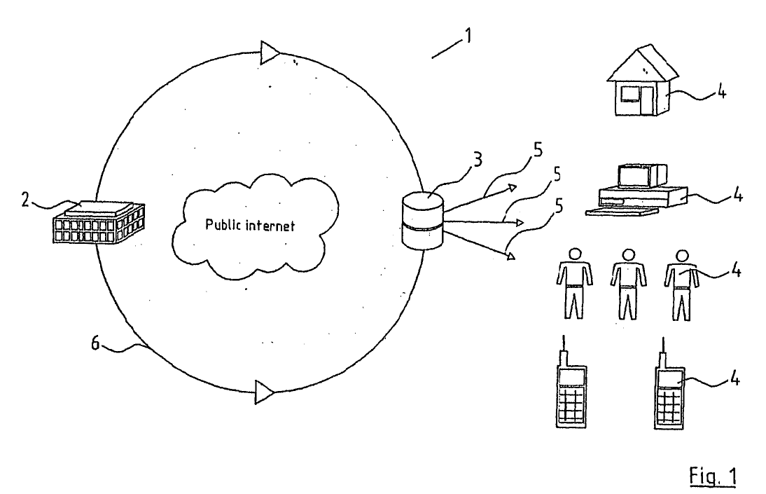

FIG. 1 is a block diagram of a system in which the method is carried out according to the invention;

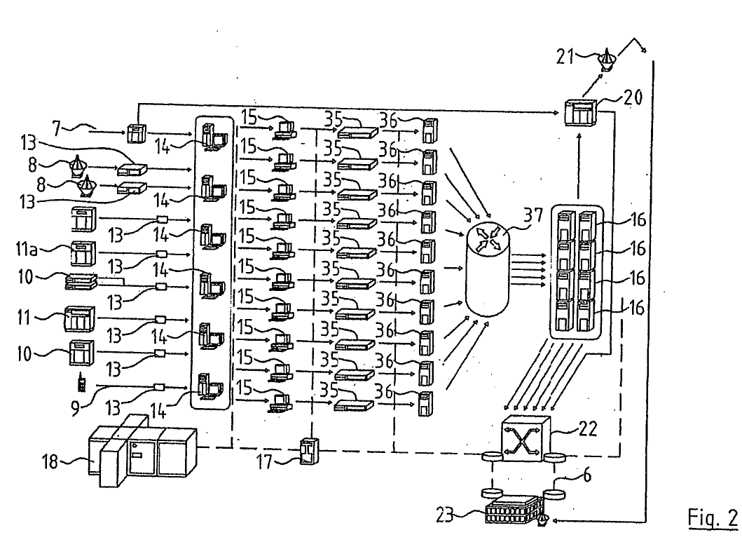

FIG. 2 is a more detailed view of the production process centre;

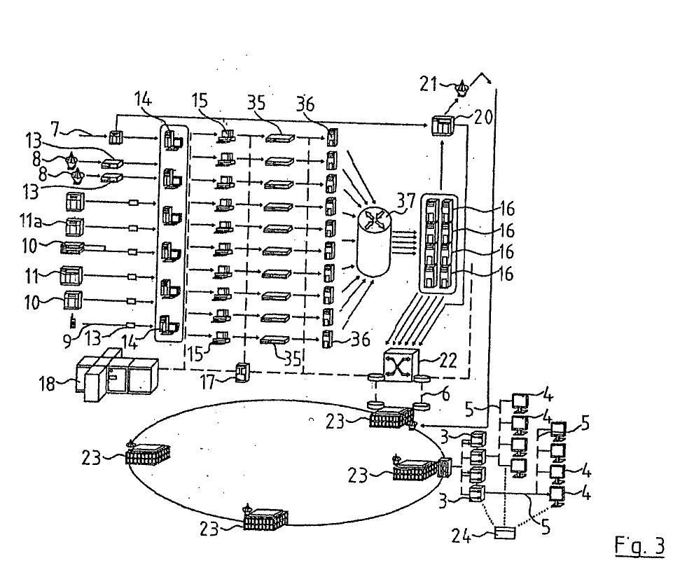

FIG. 3 is a more detailed view of the system in which the method is carried out;

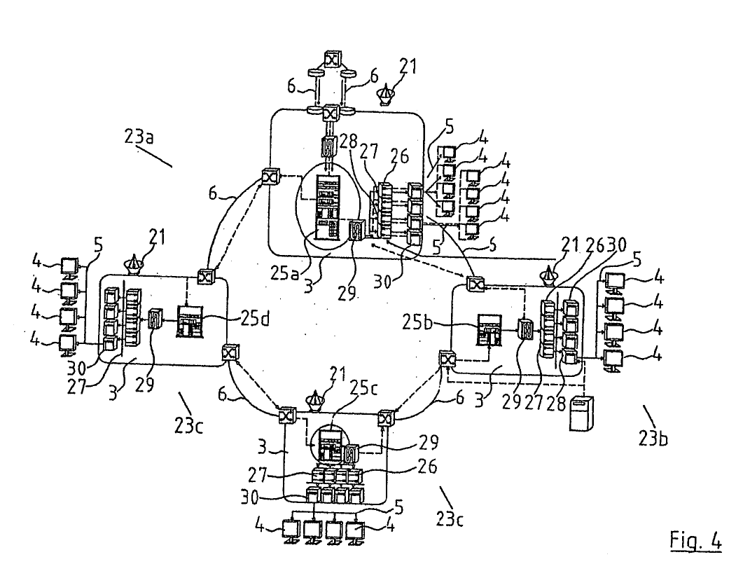

FIG. 4 is a block diagram showing the connection of the data centre computer to the production process centre and the service provider computer;

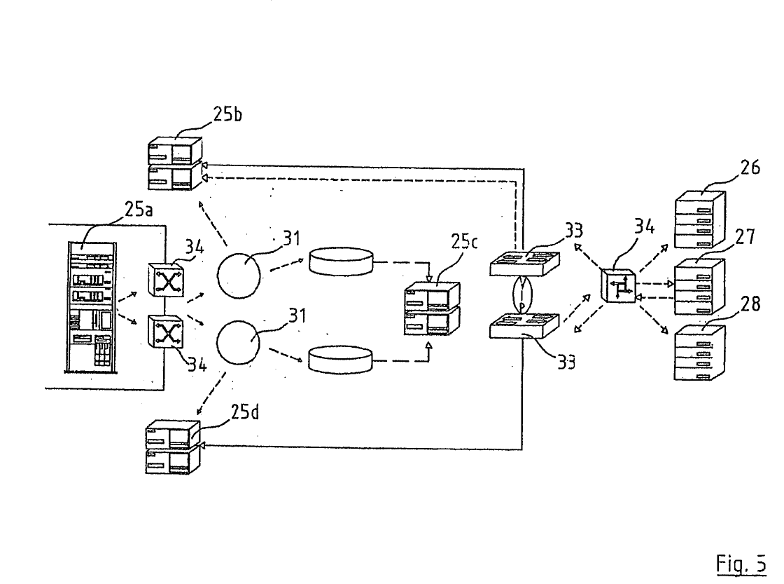

FIG. 5 is a detailed view of the flow of television program viewing format from the production process centre to the client device;

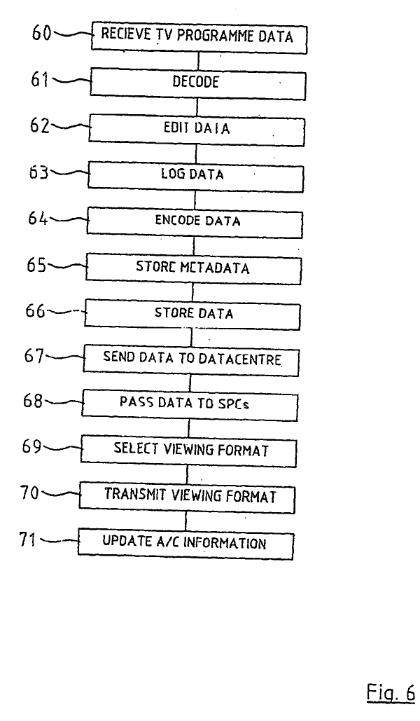

FIG. 6 is a flow diagram of the method according to the invention;

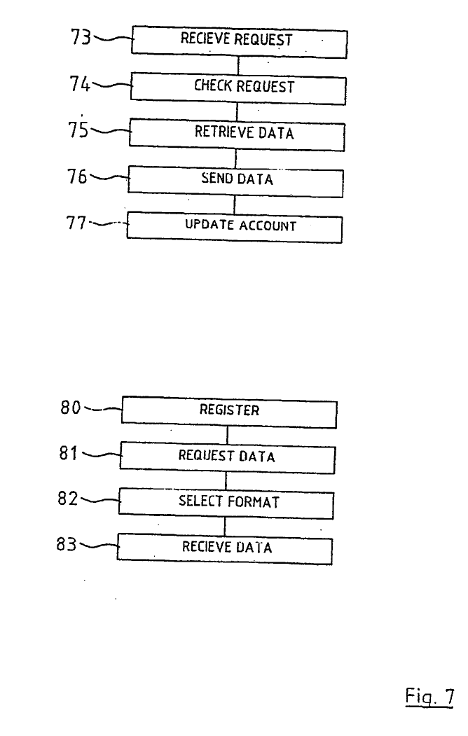

FIG. 7 is a flow diagram of the method of controlling the transmission of television quality programmes by a service provider; and

FIG. 8 is a flow diagram of a client device making a television programme viewing request including registration.

Referring now to the drawings and initially to FIG. 1 thereof there is shown a system for broadcasting television-quality programmes to a client device indicated generally by the reference numeral 1. The system comprises a production process centre (PPC) 2, a remote service provider computer 3 and a plurality of remote client devices 4 connected to the remote service provider computer 3 by way of uncontended connection lines 5. The system further comprising a dedicated uncontended connection line 6 interconnecting the PPC 2 and the service provider computer 3. In use, the PPC 2 receives television programme data from a remote programme source (not shown) and processes the received television programme data and converts the television programme data into a plurality of digital television viewing formats. The PPC 2 transmits at least one of the television programme viewing formats to the remote service provider computer 3 along the dedicated uncontended connection line 6. The service provider computer 3 thereafter transmits one television programme viewing format to the remote client device 4 over the uncontended broadband connection line 5.

Referring now to FIG. 2 of the drawings there is shown a more detailed view of the PPC 2 according to the invention. IP based Audio/Video feed 7, satellite feed 8, mobile wireless feed 9, TV feed 10, DVD jukebox feed 11 and additional studio feeds 11a are fed through the PPC 2 and passed through decoders 13. The decoded data is then passed through editing stations 14 where ad insertion and additional editing of the decoded signal may be carried out. The edited television programme data is then forwarded to the video and audio loggers 15 where a copy of the television programme data is taken before converting the data into a single SDI signal or multi-format signal in converters 35. Converters 35 further comprise pre encoders (not shown) for pre-encoding of television programme data should this be deemed to be necessary. By pre-encoding the television programme data is stripped of all unnecessary data contained within the television programme data before onward transmission to signal format servers 36. The signal is drawn from the converters 35 to the signal format servers 36 and thereafter passed to a router 37 which may be a multi-format router for onward transmission to the multiple encoding stations 16 where data is encoded into a plurality of television program viewing formats. The encoded data is then transmitted to the satellite uplink 21 via statistical multiplexers (MUX) 20 and to the output link 22 before being transmitted to the data centre computer 23 over the dedicated uncontended connection line 6. There is further shown network attached storage 18 and database 17 for storage of television programme viewing formats and metadata respectively.

Referring now to FIG. 3 of the drawings there is shown a more detailed view of the system in which the method is crried out. The PPC 2 receives television programme data from a number of remote television program sources. These television programme sources include IP based audio/video feed 7, satellite feed 8, mobile wireless feed 9, as well as TV feed 10, DVD assets and feed 11 and additional studio feed 11a. The IP based audio/video feed 7 is sent to Internet Protocol (IP) media server 12 as well as being sent directly to the primary media server (not shown) in datacentre 23 as well as to the multiplexer 20, while the remaining feeds are sent to multiple signal decoders 13 where decoding and decryption may take place. The IP based audio/video feed may be sent through editing stations if desired. The feeds are decoded into multi format before being passed to editing station 14. Additional editing such as ad insertion, subtitling and other standard editing is carried out on the multi format feeds in editing station 14. There is further provided video and audio loggers 15, multiple encoding stations 16, database 17, network attached storage 18 and Digital Linear Tape (DLT)/DVD jukebox 19. Once the SDI multi format data has passed through editing station 14 the edited data is sent to the audio and video loggers 15 where a copy of the data is logged and thereafter the data is passed to converters 35. In the converters 35 the data is converted into standard SDI or multi format before being sent to signal format servers 36 and then onwards to router 37. The router sends the data on to the multiple encoding stations 16 where the data is encoded into a plurality of digital television programme viewing formats. These digital television programme viewing formats include but are not limited to MPEG 1 [Registered Trade Mark] (RTM), MPEG 2 (RTM), MPEG 4 (RTM), MP 3 (RTM), Real Networks (RTM), Windows Media (RTM), Quick Time (RTM), Packet Video (RTM) and Emblaze (RTM).

Having passed through the loggers 15 and multiple encoding station 16 the encoded television programme viewing formats will have metadata associated therewith. This metadata is sent to database 17, which will manage all the data associated with a particular piece of television programme data. A copy of the encoded television programme viewing formats is sent to the Network Attached Storage (NAS) 18 and the DLT/DVD jukebox as archive copies and backup archive copy respectively. The data is also sent to a statistical multiplexer 20 where it is prepared to be sent via satellite uplink 21 and output link 22 over the dedicated uncontended connection line 6 to the data centre computer 23. The dedicated uncontended connection line 6 is a dual connectivity connection line. This dual connectivity line leaves the production process centre (2) at two separate distinct points and transfers the data to the data centre computer 23, entering the data centre computer at two separate distinct points also. This allows for the required level of redundancy to allow for the failure of one of the lines at any given time. The satellite uplink 21 allows for additional redundancy for the system. Each of the data centre computers 23 has a plurality of service provider computers 3, in this case Internet Service Providers (ISPs) or could be cable or mobile operators, satellite service providers or corporate LANs/WANs connected thereto. The service providers have access to secure transaction and ad insertion servers 24 where additional editing of the television program viewing formats may be carried out. Once any desired additional editing has been carried out a television program viewing format is transmitted to a client device 4 over the uncontended broadband connection line 5. There are a plurality of data centre computers 23 all connected to each other in a ring network. The interconnection between one data centre computer and the next adjacent data centre computer being an uncontended dedicated connection line. In this way the minimum amount of connection line necessary may be used. Furthermore, in this way it is private, uncongested, uncontended, secure, manageable and quantifiable.

FIG. 4 shows a more detailed view of the ring network of data centre computers 23a-23d. Data centre computer 23a is the primary data centre and hosts the primary media server 25a. Data centres 23b to 23d are secondary data centres hosting media server cache boxes 25b-25d respectively. The secondary data centres 23b -23d could each host a media server if the processing load required of them so demanded. Television program viewing formats are received from the production process centre (not shown) over the dedicated uncontended dual connectivity connection line 6 by the primary media server 25a in the data centre computer 23a. This datacentre computer 23a is the closest geographically to the production process centre (2). A dual primary media server 25a, and subsequently the media server cache boxes 25b-25d receive the television program viewing formats and pass the television program viewing formats to their respective service provider computers 3. The service provider computers 3 include an ISP 26, a cable operator service provider 27 and a mobile communications network service provider 28. The television programme viewing formats are passed to each of the service provider computers via a secure cross connector 29 to maintain the integrity of the feed from the dual media server 25. This also allows the media server operator to control the quality as well as the security of the data being transferred. From the service provider computers 26, 27 & 28, the television program viewing format is transferred to the service provider computers cache memory 30 for temporary storage and from there onwards to the client devices 4 over uncontended locally managed broadband connection lines 5. Each of the data centre computers 23a-23d is connected to the next adjacent data centre computer 23a-23d by way of the dedicated uncontended connection line 6. This dedicated uncontended connection line 6 between a pair of data centres is a back channel multiple cross connect. Essentially there are a plurality of dedicated uncontended connection lines each of which is operated by a carrier. The system is therefore carrier neutral and any one of the dedicated uncontended back channel multiple cross connect connection lines may be used. Each of the data centre computers may be provided with a secure transaction and ad insertion server 24 for localised editing of the television program viewing formats. Each data centre is also provided with a satellite uplink/downlink 21 for reception of television programme viewing formats from the production process centre 2. This allows for redundancy should the dual connectivity dedicated uncontended connection line fail or if the data centre should experience any other difficulties.

FIG. 5 shows a more detailed view of the flow of television program viewing formats from the production process centre 2 to the client device 4. Television programme viewing formats are received from the PPC (not shown) by the primary media server, 25a. From there the television programme viewing data is passed over a tier one private network 31, via cross connects 29 labelled 32, 33, 34 to the media server cache boxes 25b, 25c and 25d. From the media cache boxes 25c, the television programme viewing format is passed to a connection Network Address Translator (NAT) 32 via a layer 4 switch 33 and from there to a LAN cross-connect 34 before finally reaching the service provider computers 26, 27 & 28 for onward transmission to a client device 4. If for some reason the connection between the primary media server 25a and media server cache box 25c should fail, the television programme viewing format will be re-routed through either the media server cache boxes 25b or 25d. In this way failure of one part of the system will not result in the loss of picture to the end user.

Referring now to FIG. 6 of the drawings there is provided a flow diagram of the method according to the invention. In step 60 the PPC 2 receives TV programme data from a remote TV programme source. This can be by way of satellite feed, TV/video feed or other such known type of feed. The television programme data is then decoded in step 61 into an SDI multi format by passing the data through a decoder before sending the data in step 62 to an editing station where the television programme data is edited when required. This editing may include advertisement insertions, dubbing, sub-titling, compositing and other such editing functions. In step 63 the edited television programme data is logged and in step 64 the edited television programme data is encoded into a plurality of digital viewing formats. In step 65 the metadata relating to the television program viewing format is stored in database 17 and in step 66 the television program viewing format is stored as an archive copy in network attached storage 18 as well as DVD jukebox 19 as a further archive copy. In step 67 the television programme viewing formats are sent to the data centre 23 by way of the satellite and landline dedicated uncontended connection line. On receipt, the data centre computer 23 transfers the television programme viewing format to the service provider computers 3 and to the media server cache boxes 25b-25d in step 68. In step 69 the service provider computer retrieves the appropriate television programme viewing format for the client device 4 that wishes to view the data before transmitting that television programme viewing format to the client device 4 in step 70. Finally, in step 71 the service provider computer 3 updates the account information and sends this back to the client device 4 or other interested party. It will be appreciated that not all the steps described in FIG. 6 are necessary in certain circumstances to achieve the desired technical effect.

Referring now to FIG. 7 of the drawings there is shown a flow diagram of a method of controlling broadcast of a television quality programme to a client device by a service provider computer 3, 26, 27, 28. In step 73 the service provider computer 3 receives a television programme viewing request from a client device 4 over the uncontended broadband connection line 5. This request is checked by the service provider computer 3 to ensure that the request originated from a client device 4 that is registered with the service provider and authorised to make such a request. In step 75 the television program viewing formats associated with the television programme viewing request are retrieved by the service provider computer 3. This television programme viewing format may have already been sent by the PPC to the service provider computer 3 over the dedicated uncontended connection line 6. If the television programme viewing format has already been sent by the PPC to the service provider computer, the television programme viewing format will be stored in service provider cache memory 30. In step 76 the service provider computer 3 transmits the television programme viewing format to the client device and in step 77 the service provider computer updates the account information of the client device that made the request.

Referring now to FIG. 8 of the drawings, there is shown a flow diagram of a client device making a television programme viewing request including registering with the system. In step 80 the client device owner registers the client device 4 with the system by subscribing to the service offered by the service provider computer. This registration need only be carried out once before the first television programme viewing request is made. In step 81 the client device 4 makes a television programme viewing request to the service provider computer 3 and in step 82 the client device selects a television programme viewing format to be sent by the service provider computer. In step 83 the client device 4 receives the television programme viewing format from the service provider computer 3 over the uncontended broadband connection line.

In this specification the service provider computer 4 is provided by an Internet Service Provider (ISP). The service provider could equally well be provided by a cable service provider or a mobile communication network service provider. In the case of the mobile communication network service provider the client devices include mobile telephones. In this way television quality programmes may be broadcast to a mobile telephone without a large memory being required by the telephones to buffer all of the television quality viewing format being sent to the mobile telephone.

The term television programme viewing format has been used to describe the television programme encoded into one of a number of different formats including but not limited to Real Networks (RTM), Windows Media (RTM), Quick Time (RTM), MPEG1 (RTM), MPEG 2 (RTM), MP 3 (RTM), MPEG 4 (RTM), Packet Video (RTM) and Emblaze (RTM). What is understood is that due to the variety of types of software running on different machines as well as the variety of different viewing formats available all the client devices will not necessarily have the same viewer installed as each other and will require the television programme in a particular format to be sent to each machine. In this way the multiple encoding stations 16 are designed in a modular fashion to allow for addition of further encoders as new formats come on to the market. When a client device receives a format they are simply receiving the television programme in the format that they have the viewer for.

The term uncontended has been used throughout this specification in relation to the dedicated uncontended connection line 6 between the PPC and the data centre computers 23 and the uncontended broadband connection line 5 between the service provider computers 3 and the client devices 4. By uncontended what is meant is that the user of the line has a guaranteed amount of bandwidth at all times on that line. If the client device needs 512 K bit at all times then the user will have sole access to the 512 K bit of bandwidth on the line. No other users have access to that bandwidth on the line and it is essentially a private network. This private network will guarantee a quality of service necessary to broadcast television quality programmes to the client devices 4 from the production server. By obviating the need of going through the public internet the invention has avoided the problems of having to tunnel through the internet and all the congestion associated therewith. This is essentially the basis of the invention as it enables a quality of service that was not previously possible. Again by congestion we mean the queues that appear at certain points due to a large number of users trying to use a particular route, this often happens when there is a large demand for a particular web site or if insufficient bandwidth has been provided for the users in a particular location. Costs of delivering the network may be minimised by having the datacentres in a place where several service providers have a peering presence. One such place is the Chicago NAP where hundreds of service providers may be connected to by a single datacentre computer.

In this specification the term remote has been used at various times in relation to the PPC 2, the service provider computer 3, the client device 4 and various other pieces of apparatus. By remote, not only do we necessarily mean physically separate but can also mean in another jurisdiction. Due to the nature of the invention it is envisaged that the PPC 2 could be in one jurisdiction, the service provider computer 3 could be in another jurisdiction and the client devices could be in another still jurisdiction. Alternatively two or more of the above may be in the same jurisdiction yet simply separated from each other.

It is further envisaged that there may come a stage in which the television quality programmes will be automatically available through service provider computers and will be permanently plummed into a client device. In this way the client no longer has to make a request by selecting a particular function on the client device but simply turning the permanently plummed client device on will constitute the client device making a television programme viewing request. Although in the description of the invention the production server computer receives programme data from remote programme sources, the production server computer could have programme data created internally and remote would simply mean in another part of the production server computer itself.

Editing of the programme data may be carried out at the PPC, the service provider computer or the datacentre computer. By carrying the editing out at either the PPC or the datacentre computer greater control over content of the programme data may be achieved. By having the editing carried out at the datacentre computer locality specific editing may be carried out such as ad insertion or dubbing into a particular language.

It will also be understood from the foregoing description that various other features of the invention may be introduced. Templating formats for each of the devices may be supplied to the client device user giving standard templates for the device that they are using. This will further reduce the content being broadcast to a device and allow better quality pictures of higher bit quality to be sent to the client device. These templates can give further options particularly to mobile device users such as video clips and thumbnails of content currently being viewed. Additionally teletext (Registered Trade Mark) and teleprompt scripts may be included in the content for wider application of the invention. These services can be provided in a simple and efficient manner by using the present invention. Encryption of data as well as both tracking and logging services may be provided as useful features to the clients and more particularly the service provider computer owners which are now essentially the clients of the production process centre operator. By introducing the features of this system and by making the service provider computer operators clients of the production process centre, a sustainable always-on live television programming to remote client devices may be achieved.

What must be understood is that the PPC 2 and the service provider computer 3 may be implemented largely in software. Therefore, the invention also extends to computer programs, particularly to computer programs on or in a carrier, adapted for putting the invention into practice. The program may be in the form of source code, object code or code intermediate source and object code. The program may be stored on a carrier such as any known computer readable medium such as a floppy disc, ROM, CD ROM or DVD. The carrier may be a transmissible carrier such as an electrical or optical signal, which may be conveyed via electrical or optical cable or by radio or other means. When the program is embodied on a signal, which may be conveyed directly by a cable or other device, the carrier may be constituted by such a cable or other device means. It is further envisaged that the computer program may be stored in an integrated circuit.

In this specification the terms “comprise, comprises, comprised and comprising” as well as the terms “include, includes, included and including” or any variation thereof are deemed to be totally interchangeable and they should all be afforded the widest possible interpretation.

The invention is not limited to the embodiment hereinbefore described but may be varied in both construction and detail.

1. A method of broadcasting television-quality programmes in real time to a client device in a system comprising a Production Process Centre (PPC) (2), a remote service provider computer (3) and a plurality of remote client devices (4) each of which is connected to the service provider computer (3) by way of an uncontended communication channel (5), the method comprising the production process centre (2) transmitting a television quality programme to the remote client device (4) via the remote service provider computer (3), the method further comprises the step of:
(a) the production process centre (2) receiving television programme data from a remote television programme source;
(b) the production process centre (2) processing the received television programme data and converting the television programme data into a plurality of digital television programme viewing formats;
(c) transmitting at least one of the television programme viewing formats to the remote service provider computer (3) along a dedicated uncontended connection line (6) interconnecting the production process centre (2) and the remote service provider computer (3); and
(d) the service provider computer (3) transmitting one television programme viewing format to the remote client device (4) over the uncontended communication channel (5).

2. A method as claimed in claim 1 in which the remote service provider computer (3) comprises an Internet Service Provider (ISP) computer and the step of transmitting at least one of the television programme viewing formats to the service provider computer (3) comprises transmitting at least one of the television programme viewing formats to the ISP computer.

3. A method as claimed in claim 1 in which the remote service provider computer (3) comprises a mobile communications network service provider computer and the step of transmitting at least one of the television programme viewing formats to the service provider computer (3) comprises transmitting at least one television programme viewing format to the mobile communications network service provider computer.

4. A method as claimed in claim 1 in which the remote service provider computer (3) comprises a cable network service provider computer and the step of transmitting at least one of the television programme viewing formats to the service provider computer (3) comprises transmitting at least one television programme viewing format to the cable network operator computer.

5. A method as claimed in claim 1 in which the step of transmitting at least one television programme viewing format to the service provider computer (3) over a dedicated uncontended connection line (6) further comprises transmitting at least one television programme viewing format to the service provider computer over a dedicated uncontended dual connection link.

6. A method as claimed in claim 1 in which the step of transmitting at least one television programme viewing format to the service provider computer (3) over a dedicated uncontended connection line (6) further comprises transmitting at least one television programme viewing format to the service provider computer over a dedicated uncontended satellite link.

7. A method as claimed in claim 1 in which the step of processing the received television programme data further comprises decoding the received television programme data into standard Serial Digital Interface (SDI) format.

8. A method as claimed in claim 1 in which the step of processing the received television programme data further comprises decoding the received television programme data into standard multi format.

9. A method as claimed in claim 7 in which the received programme data is passed through a multiple signal decoder (13) to decode the received television programme data into standard format.

10. A method as claimed in claim 1 in which the step of processing the received television programme data further comprises editing the received television programme data.

11. A method as claimed in claim 10 in which the step of editing the received television programme data further comprises inserting advertisement commercials into the received television programme data.

12. A method as claimed in claim 1 in which the step of converting the television programme data into a plurality of digital television viewing formats comprises passing the television programme data through a multiple encoding station (16).

13. A method as claimed in claim 1 in which the method further comprises the intermediate step of logging the received television programme data in production server computer memory for future use.

14. A method as claimed in claim 1 in which the method further comprises the intermediate step of storing metadata relating to each piece of received television programme data in production server computer memory.

15. A method as claimed in claim 1 in which the method further comprises the intermediate step of pre-encoding the television programme data before converting the television programme data into a plurality of digital television viewing formats.

16. A method as claimed in claim 1 in which there is provided a data centre computer (23) having data centre memory intermediate the production process centre (2) and the service provider computer (3) and connected to the production process centre (2) and the service provider computer (3) by way of the dedicated uncontended connection line (6), and the television programme viewing format transmitted to the remote service provider computer (3) from the production process centre (2) is stored in the data centre memory, the datacentre computer (23) transmitting the television programme viewing format onwards to the remote service provider computer (3).

17. A method as claimed in claim 16 in which there are a plurality of data centre computers (23), each data centre computer (23) being connected to at least one other data centre computer (23) by way of a back channel multiple cross connect uncontended connection line, the method including the step of each data centre (23) sharing a television programme viewing format with the data centre computer (23) connected thereto over the back channel multiple cross connect uncontended connection line.

18. A method as claimed in claim 16 in which the data centre computer (23) is provided with means to edit the television programme viewing format and the method further comprises the step of the data centre computer editing the television programme viewing format received from the production server computer (2).

19. A method as claimed in claim 18 in which the step of editing the television programme viewing format at the datacentre computer (23) further comprises inserting location specific advertisement commercials into the television programme viewing format.

20. A method as claimed in claim 1 in which the method further comprises the initial step of the remote client device (4) selecting a television programme viewing format for reception from the remote service provider computer (3).

21. A method of controlling the transmission of television quality programmes to a remote client device (4) by a service provider computer (3), in a system comprising a plurality of remote client devices (4) each connected to the service provider computer (3) by way of an uncontended broadband connection (5), and a remote production process centre (2) connected to the service provider computer (3), the service provider computer (3) receiving a television quality programme from the remote production process centre (2) and the service provider computer (3) transmitting the television quality programme to the remote client device (4), the method further comprises the steps of:
(a) the service provider computer (3) receiving television-quality programmes from the remote production process centre (2) over a dedicated uncontended connection line (6) interconnecting the remote production process centre (2) and the service provider computer (3) in a plurality of television-quality programme viewing formats; and
(b) on request from one of the remote client devices (4), transmitting one of the television-quality programme viewing formats received from the remote production process centre (2) to the remote client device (4) over the uncontended broadband connection line (5).

22. A method as claimed in claim 21 in which the initial step of the remote client device (4) selecting a television-quality programme viewing format is performed.

23. A method as claimed in claim 21 in which the service provider computer (3) comprises an internet service provider (ISP) computer and the ISP computer performs the steps of receiving the television-quality programmes and transmitting one of the television-quality programme viewing formats to the remote client device (4).

24. A method as claimed in claim 21 in which the service provider computer (3) comprises a mobile communications network service provider computer and the steps of receiving the television-quality programmes and transmitting one of the television-quality programme viewing formats to the remote client device (4) are performed by the mobile communication network service provider computer.

25. A method as claimed in claim 21 in which the service provider computer (3) comprises a cable network service provider computer and the cable network service provider computer performs the steps of receiving the television quality programmes and transmitting one of the television quality programme viewing formats to the remote client device (4).

26. A method as claimed in claim 21 in which the method further comprises the step of inserting advertisement commercials into the television-quality programmes by the service provider computer (3) before onward transmission to the remote client device (4).

27. A method as claimed in claim 21 in which the method further comprises the step of the service provider computer (3) monitoring television-quality programmes sent to a remote client device (4).

28. A method as claimed in claim 27 in which the service provider computer (3) generates billing information for a remote client device (4) based on the monitoring of television-quality programmes sent to that remote client device (4).

29. A method as claimed in claim 21 in which there is further provided a remote data centre computer (23) connected to the dedicated uncontended connection line (6) intermediate the service provider computer (3) and the remote production process centre (2) and television-quality programmes are passed through the data centre computer (23) en route to the service provider computer (3).

30. A method as claimed in claim 29 in which the method comprises the step of inserting advertisement material into the television quality programmes by the remote data centre computer (23) before onward transmission to the service provider computer (3).

31. A method of receiving real time television-quality programmes in a client device (4), the client device being part of a system comprising a plurality of client devices (4) each connected to a remote service provider computer (3) by way of an uncontended communication link (5), and a remote production process centre (2) connected to the remote service provider computer (3) by a dedicated uncontended connection line (6) therebetween, the method comprising the steps of:
(a) the client device (4) making a television-quality programme viewing request to the remote production process centre (2) via the remote service provider (3); and
(b) receiving the television-quality programme associated with the television quality programme viewing request in a suitable television quality programme viewing format.

32. A method as claimed in claim 31 in which the method includes the initial step of the client device (4) selecting a suitable television quality programme viewing format from a plurality of available television quality programme viewing formats.

33. A method as claimed in claim 31 in which the service provider computer (3) is an Internet Service Provider (ISP) computer and the step of making a television quality program viewing request to the remote production process centre (2) is made via the ISP computer.

34. A method as claimed in claim 31 in which the service provider computer (3) is a mobile communications network service provider computer and the step of making a television-quality program viewing request to the remote production process centre (2) is made via the mobile communications network service provider computer.

35. A method as claimed in claim 31 in which the service provider computer (3) is a cable network service provider computer and the step of making a television quality program viewing request to the remote production process centre (2) is made via the cable network service provider computer.

36. A method as claimed in claim 31 in which the method further comprises the initial steps of the client device (4) registering with the remote service provider computer as a system user.

37. A system for broadcasting television-quality programmes to a client device (4) comprising a production process centre (2), a remote service provider computer (3) and a plurality of remote client devices (4) each connected to the remote service provider computer (3) by way of an uncontended communication link (5), the production process centre (2) transmitting a television-quality programme to the remote client device (4) via the remote service provider computer (3), the system further comprising:
(a) a dedicated uncontended connection line (6) inter-connecting the production process centre (2) and the service provider computer (3), the production process centre (2) sending the television-quality programme to the service provider computer (3) along the dedicated uncontended connection line (6);
and the production process centre (2) comprising:
(b) a receiver for receiving television programme data from a remote television programme source;
(c) a processor for processing the received programme data and means to convert the television programme data into a plurality of digital television viewing formats;
(d) a transmitter for transmitting the television quality programme in at least one of the digital television viewing formats to the service provider computer along the dedicated uncontended connection line.

38. A system as claimed in claim 37 in which the remote service provider computer (3) comprises an Internet Service Provider (ISP) computer.

39. A system as claimed in claim 37 in which the remote service provider computer (3) comprises a mobile communications network service provider computer.

40. A system as claimed in claim 37 in which the remote service provider computer (3) comprises a cable network service provider computer.

41. A system as claimed in claim 37 in which the production process centre's processor further comprises means to decode a plurality of incoming data formats into a single standard format.

42. A system as claimed in claim 37 in which the production process centre comprises a pre-encoder to pre-encode the television programme data.

43. A system as claimed in claim 37 in which the production process centre's means to convert the television programme data into a plurality of digital television viewing formats comprises a multiple encoding station (16).

44. A system as claimed in claim 37 in which the production process centre (2) has production process centre memory and means to log television programme data in production process centre memory.

45. A system as claimed in claim 44 in which the production process centre has means to store metadata relating to television programme data in production process centre memory.

46. A system as claimed in claim 37 in which the dedicated uncontended connection line (6) is a dual-connectivity dedicated uncontended connection line.

47. A system as claimed in claim 37 in which there is additionally provided a satellite link (21) connecting the production process centre (2) and the remote service provider computer (3).

48. A system as claimed in claim 37 in which there is provided a remote data centre computer (23) connected to the dedicated uncontended connection line (6) intermediate the production process centre (2) and the remote service provider computer (3) acting as an interface between the production process centre (2) and the remote service provider computer (3), all data traffic between the production process centre (2) and the service provider computer (3) passing through the remote data centre.

49. A system as claimed in claim 48 in which the remote data centre computer further comprises a media server computer having means to receive and transmit television quality programming data.

50. A system as claimed in claim 48 in which there are a plurality of data centres, each datacentre being connected to at least one other datacentre by way of a multiple back channel cross connect uncontended connection line.

51. A system as claimed in claim 48 in which there are a plurality of service provider computers located adjacent each data centre computer (23) and the data centre computer (23) controls the flow of television-quality programme data to each of the service provider computers (3).

52. A system as claimed in claim 48 in which the data centre computer (23) comprises means to edit television programme data received from the production process centre (2).

53. A system for broadcasting television-quality programmes to a remote client device (4) comprising a remote production process centre (2), a service provider computer (3) and a plurality of remote client devices (4) each connected to the service provider computer (3) by way of an uncontended communication channel (5), the service provider computer (3) receiving a television-quality programme from the remote production process centre (2) and transmitting the television-quality programme onwards to a remote client device (4), the system further comprising:
(a) a dedicated uncontended connection line (6) interconnecting the remote production process centre (2) and the service provider computer (3), the service provider computer (3) receiving the television-quality programme from the remote production process centre (2) over the dedicated uncontended connection line (6) in a plurality of television-quality programme viewing formats; and
(b) the service provider computer (3) having a receiver for receiving a television viewing request from a remote client device and a transmitter for transmitting one of the television-quality programme viewing formats over the uncontended connection line (5) to the remote client device.

54. A system as claimed in claim 53 in which there is provided a remote data centre computer (23) connected to the dedicated uncontended connection line (6) intermediate the service provider computer (3) and the remote production process centre (2) and television-quality programmes are passed through the data centre computer (23) en route to the service provider computer (3).

55. A system as claimed in claim 53 in which the service provider computer (3) is an Internet Service Provider (ISP) computer.

56. A system as claimed in claim 53 in which the service provider computer (3) is a Mobile Communications Network service provider computer.

57. A system as claimed in claim 53 in which the service provider computer (3) is a cable network service provider computer.

58. A system as claimed in claim 53 in which the service provider computer (3) has means to monitor the television viewing requests of each of the remote client devices (4).

59. A system as claimed in claim 53 in which the service provider computer (3) has means to edit the television quality programmes.

60. A computer program comprising program instructions for causing a computer to carry out the method steps performed by the production process centre (2) in claim 1.

61. A computer program comprising program instructions for causing a computer to carry out the method steps performed by the service provider computer (3) in claim 21.

62. A computer program as claimed in claim 60 in which the program is stored on a computer readable medium.

63. A computer program as claimed in claim 60 in which the program is stored on a carrier signal.
